(19) United States
(12) Patent Application Publication
(10) Pub. No.: US 2012/0176825 A1
(43) Pub. Date: Jul. 12, 2012

(54) Auxiliary automotive power supply

(76) Inventor: Charles Jon Lahti, Hoyt Lakes, MN (US)

(21) Appl. No.: 12/930,445

(22) Filed: Jan. 7, 2011

(51) Int. Cl. H02M 7/155

(52) U.S. Cl. 363/125

(57) ABSTRACT

The purpose for this device is to provide electrical power to an automotive electrical control system from a residential electrical service. The power from an auxiliary power supply will maintain the operational data stored within the memory of the automotive computer and data within other electronic devices. This is accomplished by maintaining an energized electrical system, which will prevent the normal discharge of the battery due to parasitic loads. This device has precise voltage regulation to maintain the proper voltage level of the electrical system with or without the normal storage battery being present, Parasitic loads are those loads that require electrical energy when the automobile engine is not running.

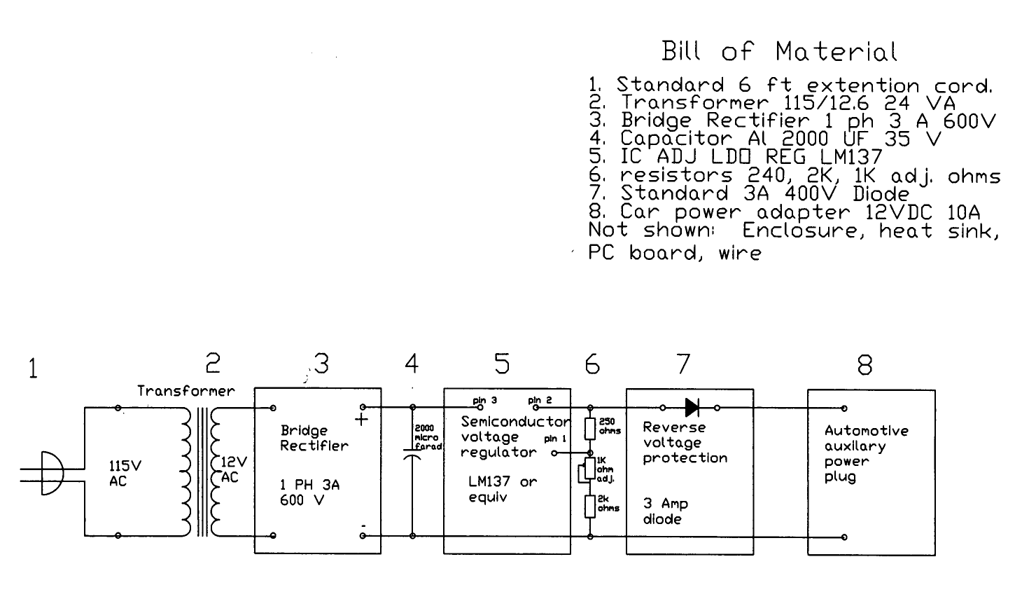

### CROSS-REFERENCE TO RELATED APPLICATIONS

Not Applicable

### BACKGROUND OF THE INVENTION

This device was designed and prototyped by the need to have a means to keep an automotive battery charged during a long period of not using the automobile. I have an automobile that is in a home garage, and left idle for long periods of time, the battery becomes completely discharged. To prevent this problem the following design parameters were implemented:
(1). To maintain the electrical system voltage at normal operating level.
(2). Provide a means that anyone can use the device that is not familiar with the electrical system of an automobile.
(3). Keep the device simple so that it is affordable.
(4). Make the device with standard electronics components.

Devices may effect automotive batteries in one or more of the four possible states, (A) permit battery charging, (B) permit battery discharging, (C) preventing battery charging or (D) preventing battery discharging. This device will prevent the battery from discharging. Therefore: this device belongs in class 320 electricity: battery or capacitor charging or discharging of the United States Patent Classification (USPC) System. On review of the sub codes I did not find one that is applicable to this device.

The purpose for this device is to provide electrical power to an automotive electrical system from a residential electrical service. The power from an auxiliary power supply will maintain the operational data stored within the memory of the automotive computer and data within other electronic devices. This is accomplished by maintaining an energized electrical system, which will prevent the normal discharge of the battery due to parasitic loads. This device has precise voltage regulation to maintain the proper voltage level of the electrical system with or without the normal storage battery being present, Parasitic loads are those loads that require electrical energy when the automobile engine is not running.

### BRIEF SUMMARY OF THE INVENTION

This device will provide a source of electrical power to prevent the discharge of the automotive storage battery due long term idle periods. The only requirement for use is to plug the 115VAC cord into a standard residential electrical service outlet and plug the 12VDC plug in to an automotive power output receptacle. In the past the battery was permitted to discharge after which a person would be required to connect a battery charger to the discharged battery via opening the hood and finding the correct terminal to clip the correct lead to. Women normally would call a service station for help to get their vehicle started.

The operational parameters of the internal combustion engine are monitored over a number of start, that data would be stored in the automobile onboard computer, and error codes would be generated, which is lost if the battery is permitted to discharge.

### BRIEF DESCRIPTION OF THE SEVERAL VIEWS OF THE DRAWING

One electrical schematic drawing titled: Auxiliary Automotive Power Supply

### DETAILED DESCRIPTION OF THE INVENTION

This device is designed for easy use. The normal residential power system of 115 VAC is connected via a standard 115 V AC two prong plug. The output power is via way of a standard automotive cigarette lighter and/or auxiliary power connection. This feature provides ease of use to all people ill-relevant of age and/or gender and is the safest means for untrained personal. The device does not require anyone to open the hood of the automobile to connect to the battery terminals.

The device has short circuit protection, thermal overload protection and output reverse polarity connection protection. The operational voltage is adjustable between 10 to 15 V DC, with normal output voltage set to 13.8 V DC thus preventing gassing within the electrical system battery. This load regulation is typically 0.3 percent.

The device consists of an alternating voltage to direct voltage energy converter. The alternating voltage of nominal 115 V AC is converted to 17 V DC using a transformer and full wave rectifying bridge. A filter capacitor is utilized to reduce the ripple of the rectified direct voltage, improve voltage stability and power transfer characteristic. Items 1, 2, 3, and 4 on drawing Auxiliary Automotive Power Supply enclosed.

The next section consist of a semiconductor voltage regulator intergraded chip. The semiconductor chip is self-limiting in power transfer, thermal overload protection and short circuit protection. The semiconductor chip is utilized in the floating operation mode providing electrical isolation within the system. The output voltage is controlled by a voltage divider circuit consisting of three resistors of which one is adjustable and sets the output voltage during final testing in the factory. Items 5 and 6 on drawing Auxiliary Automotive Power Supply enclosed.

The output stage provides both reverse power flow protection and ease of connection to the automotive electrical system. All electrical components are installed within a plastic box to provide double isolation for energized parts. Items 7 and 8 on drawing Auxiliary Automotive Power Supply enclosed.

1. This device has precise voltage regulation to maintain the proper voltage level of an automobile electrical system, with or without the normal storage battery being present, to eliminate the effect of parasitic loads that normality discharges an automotive electrical battery.
